(19) United States
(12) Patent Application Publication
(10) Pub. No.: US 2015/0323345 A1
(43) Pub. Date: Nov. 12, 2015

(54) Encoder System With Error Detection And Signal Conditioning Circuits

(71) Applicant: Avago Technologies General IP (Singapore) Pte. Ltd., Singapore (SG)

(72) Inventors: Huei Koon Yeoh Yong, Penang (MY); Kheng-Hin Toh, Penang (MY); Swee Wah Lee, Kedah (MY)

(73) Assignee: Avago Technologies General IP (Singapore) Pte. Ltd., Singapore (SG)

(21) Appl. No.: 14/275,302

(22) Filed: May 12, 2014

(51) Int. Cl. G01D 5/12; G01D 5/347

(52) U.S. Cl. CPC G01D 5/12; G01D 5/3473

(57) ABSTRACT

An encoder system for detecting a movement of a part of a motor system is disclosed. The encoder system may comprise a sensor array, a detection controller, and an error detector circuit. The sensor array may be configured to generate first and second periodic signals in accordance to the movement of the part of the motor system. The detection controller may be coupled to the sensor array and may be configured to generate a periodic control signal derived from at least one of the first and second periodic signals. The error detector circuit may be coupled to the sensor array and the detection controller and configured to generate an error signal when at least one of the first and second periodic signals is outside a predetermined range when the periodic control signal is triggered.

### BACKGROUND

Encoders may be widely used in the field of industrial automation, such as robotics, automated machinery, other machineries, and a variety of other applications. Encoders may also be commonly used in consumer products, such as printers.

Encoders may be configured to generate signals that correspond to the position, velocity or acceleration of a component in a system in which the encoder is operating. The encoders may provide high accuracy and resolution signals so as to ensure proper operation of the whole system. For some of the industrial applications, the quality of the signals generated by the encoders may have a direct impact on the physical safety of the users of the system.

While using encoders in these applications provide many advantages, some challenges may still remain. For example, additional configuration and functionality of the encoder may be desired to address contamination or emitter degradation issues.

### BRIEF DESCRIPTION OF THE DRAWINGS

Illustrative embodiments by way of examples, not by way of limitation, are illustrated in the drawings. Throughout the description and drawings, similar reference numbers may be, but are not necessarily, used to identify similar elements. The drawings are for illustrative purposes to assist understanding and may not necessarily be drawn per actual scale.

FIG. 1A illustrates a block diagram of a motor system with an encoder system;

FIG. 1B illustrates graphs of a periodic control signal and an error signal;

FIG. 1C illustrates a block diagram of a signal conditioning circuit with a filtering circuit and graphs of reconstructed first and second periodic signals;

FIG. 1D illustrates a block diagram of a signal conditioning circuit with an amplitude adjustor circuit and graphs of reconstructed first and second periodic signals;

FIG. 1E illustrates a block diagram of an encoder system with a signal conditioning circuit;

FIG. 2A illustrates a block diagram of an encoder system;

FIG. 2B illustrates graphs of maximum and minimum point seeking signals;

FIG. 2C illustrates a block diagram of an encoder system with a delay circuit;

FIG. 2D illustrates graphs of the first, second, third and fourth periodic signals;

FIG. 2E illustrates graphs of a first delay signal and a maximum point seeking signal;

FIG. 2F illustrates a block diagram of an encoder system with an interpolator;

FIG. 2G illustrates graphs of a plurality of additional periodic signals and a maximum point seeking signal;

FIG. 2H illustrates graphs of a plurality of additional periodic signals and a maximum point seeking signal;

FIG. 2I illustrates a block diagram of an encoder system with a sample and hold circuit and a direction detector circuit;

FIG. 2J illustrates graphs of maximum point seeking signal and sampled first periodic signal;

FIG. 2K illustrates graphs of maximum and minimum point seeking signals in first and second directions;

FIG. 2L illustrates graphs of a direction change signal and an error gating signal;

FIG. 2M illustrates a block diagram of a direction detector circuit;

FIG. 2N illustrates a block diagram of an error gating circuit;

FIG. 3 illustrates a block diagram of an encoder system and graphs of first and second pair periodic signals;

FIG. 4A illustrates a flowchart showing a method for detecting error in a plurality of periodic signals of an encoder;

FIG. 4B illustrates a flowchart showing alternative method for detecting error in a plurality of periodic signals of an encoder; and

FIG. 4C illustrates a flowchart showing alternative method for detecting error in a plurality of periodic signals of an encoder.

### DETAILED DESCRIPTION

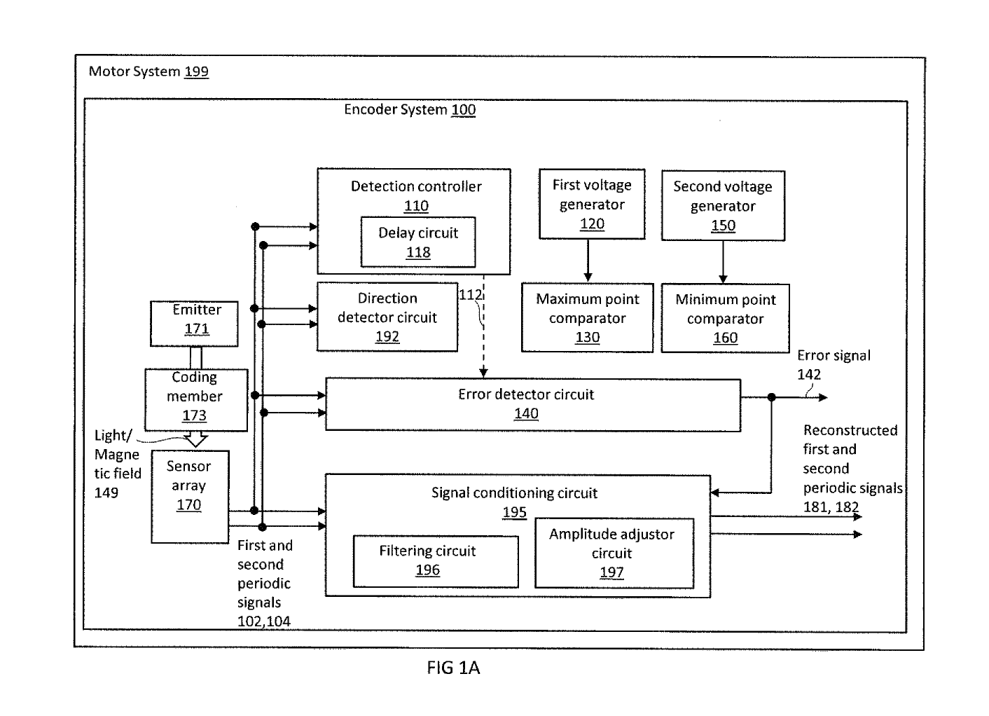

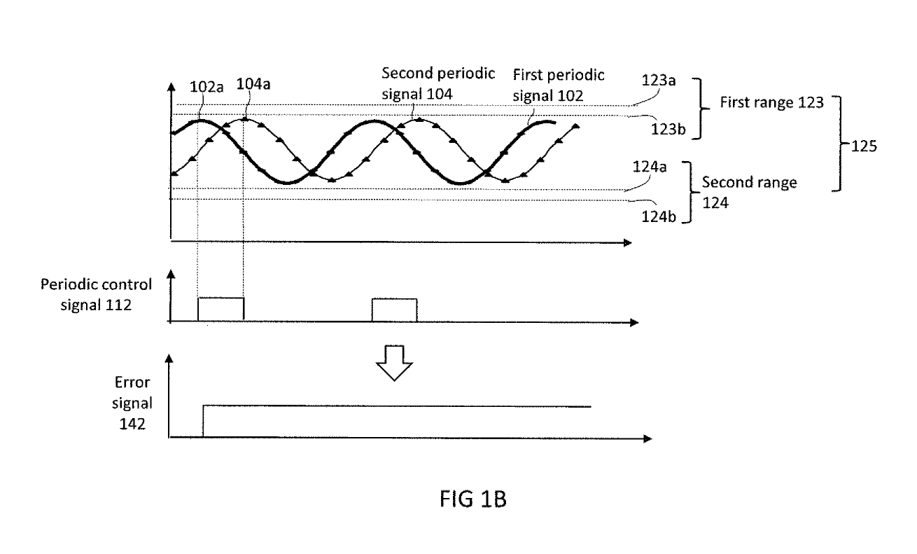

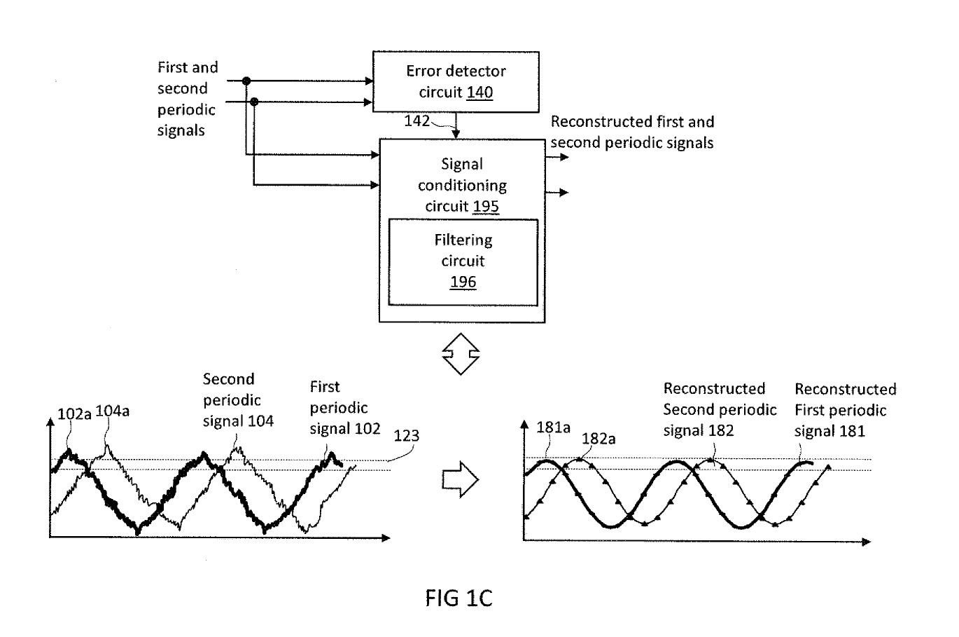

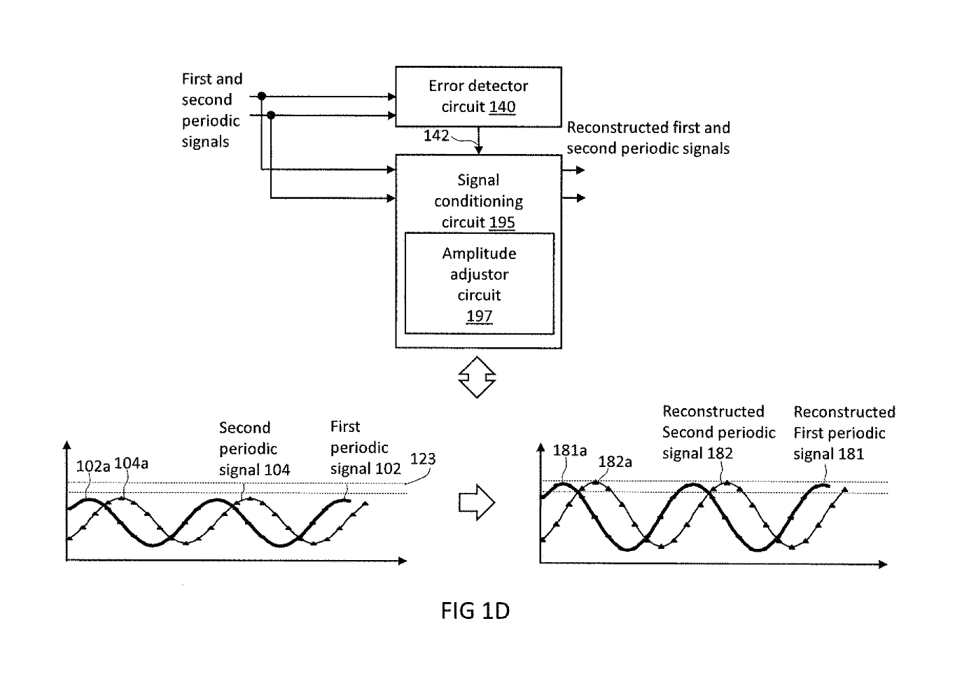

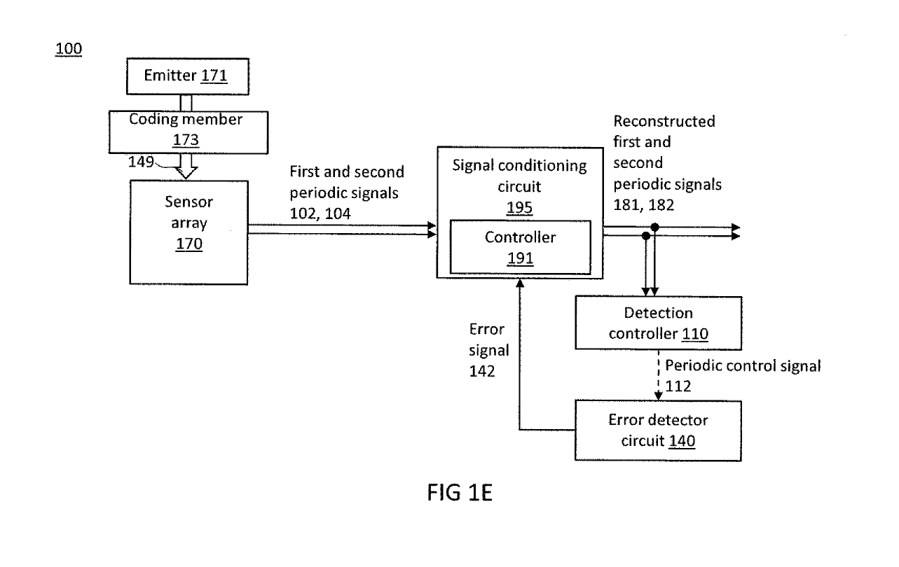

Referring to FIGS. 1A-1E, the illustrative encoder system 100 is depicted as including a sensor array 170, an emitter 171, a coding member 173, a detection controller 110, an error detector circuit 140, and a signal conditioning circuit 195.

Referring to FIG. 1A, the encoder system 100 may form a portion of a motor system 199. The encoder system 100 may be configured to detect a movement of a part of the motor system 199 such as a motor shaft. The sensor array 170 may be configured to generate first and second periodic signals 102, 104 in response to the movement of the part of the motor system 199. In one embodiment, the first and second periodic signals 102, 104 may be approximately 90 degrees out of phase. In another embodiment, the first and second periodic signals 102, 104 may be approximately 180 degrees out of phase. The first and second periodic signals 102, 104 may correspond to a position, velocity and/or acceleration of the part of the motor system 199.

In one embodiment, the encoder system 100 may be an optical encoder. The emitter 171 may be a light source such as a light emitting diode, a laser, a collection of such devices, or other type of light sources that are capable of emitting light 149. The emitter 171 may be configured to emit the light 149 to the coding member 173. The coding member 173 may be a code wheel or a linear code strip, or any other similar configurations that may be required or desired in a particular application. The sensor array 170 may configured to generate the first and second periodic signals 102, 104 in response to the reflected or transmitted light 149 from the coding member 173.

In another embodiment, the encoder system 100 may be a magnetic encoder. The coding member 173 may be a magnetized material. The sensor array 170 may be a magnetic sensor. The magnetic sensor 170 may be configured to detect the presence of a magnetic field 149 generated by the magnetized material 173. The magnetic sensor 170 may be configured to generate the first and second periodic signals 102, 104 that correspond to the movement of the part of the motor system 199.

The detection controller 110 may be coupled to the sensor array 170. The detection controller 110 may be configured to receive the first and second periodic signals 102, 104. The detection controller 110 may be configured to generate a periodic control signal 112. The periodic control signal 112 may be derived from at least one of the first and second periodic signals 102, 104. The error detector circuit 140 may be coupled to the sensor array 170 and the detection controller 110. in the'event the periodic control signal 112 is triggered, the error detector circuit 140 may be configured to generate an error signal 142 when at least one of the first and second periodic signals 102, 104 is outside a predetermined range 125.

Referring to FIGS. 1A and 1B, the detection controller 110 may be configured to generate the periodic control signal 112 as a digital signal. The error detector circuit 140 may be configured to generate the error signal 142 when the periodic control signal 112 is triggered. It should be appreciated that the term “triggered” may correspond to one or a number of conditions and/or states, one example of which occurs when the periodic control signal 112 equals to a predetermined digital value such as 0 or 1. Another example of triggering may occur when the error detector circuit 140 generates the error signal 142 at a positive edge or a negative edge of the periodic control signal 112. Still another example of triggering may occur when the detection controller 110 generates the periodic control signal 112 as an analog signal. The error detector circuit 140 may be configured to generate the error signal 142 when the periodic control signal 112 is equal to a predetermined analog value such as 1 mV or 10 mV. In yet another embodiment, the detection controller 110 may be configured to generate the periodic control signal 112 as a multiple bits signal. The error detector circuit 140 may be configured to generate the error signal 142 when the periodic control signal 112 is equal to a predetermined multi-bit value (e.g., a bit string) such as 01, 10, 110 or 001.

The encoder system may optionally comprise a direction detector circuit 192, a first voltage generator 120, a maximum point comparator 130, a second voltage generator 150, and a minimum point comparator 160. In one embodiment, the first voltage generator 120 may be configured to generate the first range 123 that comprises a first upper reference value 123a and a second upper reference value 123b. The maximum point comparator 130 may be configured to compare at least one of the first and second periodic signals 102, 104 to the first range 123 when the periodic control signal 112 is triggered. The second voltage generator 150 may be configured to generate the second range 124 that comprises a first lower reference value 124a and a second lower reference value 124b. The minimum point comparator 160 may be configured to compare at least one of the first and second periodic signals 102, 104 to the second range 124 when the periodic control signal 112 is triggered. The error detector circuit 140 may be configured to generate the error signal 142 when triggered by at least one of the maximum and minimum point comparators 130, 160. The error detector circuit 140 may be configured to generate the error signal 142 when at least one of the maximum and minimum point comparators 130, 160 indicates that at least one of the first and second periodic signals 102, 104 falls outside at least one of the first range 123 and second range 124.

In one embodiment, the direction detector circuit 192 may be configured to detect a change in direction of the movement of the part of the motor system 199. When the part of the motor system 199 moves in a first direction (e.g., a first rotational direction or first linear direction), the predetermined range 125 may correspond to the first range 123. The detection controller 110 may be configured to generate the periodic control signal 112 that indicates maximum values 102a, 104a of the first and second periodic signals 102, 104. The error detector circuit 140 may be configured to compare at least one of the maximum values 102a, 104a of the first and second periodic signals 102, 104 with the first range 123 in the first direction. The error detector circuit 140 may be configured to generate the error signal 142 when at least one of the maximum values 102a, 104a of the first and second periodic signals 102, 104 fall outside the first range 123.

When the part of the motor system 199 moves in a second direction (e.g., a direction opposite to the first direction), the predetermined range 125 may correspond to the second range 124. The direction detector circuit 192 may be configured to indicate that there is the change in direction. As a result, the error detector circuit 140 may be configured to compare at least one of the maximum values 102a, 104a of the first and second periodic signals 102, 104 with the second range 124 instead of the first range 123.

FIG. 1C illustrates an embodiment of the signal conditioning circuit 195. The signal conditioning circuit 195 may be coupled to the error detector circuit 140. The error detector circuit 140 may be configured to generate the error signal 142 when the maximum values 102a, 104a of the first and second periodic signals 102, 104 fall outside the first range 123. The signal conditioning circuit 195 may comprise a filtering circuit 196. In one embodiment, the filtering circuit 196 may be configured to filter the first and second periodic signals 102, 104 into the reconstructed first and second periodic signals 181, 182 when the error detector circuit 140 generates the error signal 142. The filtering circuit 196 may be configured to filter out noises from the first and second periodic signals 102, 104 such that the maximum values 181a, 182a of the reconstructed first and second periodic signals 181, 182 fall within the first range 123. In another embodiment, the filtering circuit 196 may be configured to filter out signals having a frequency approximately higher than 5 MHz when the error detector circuit 140 generates the error signal 142. In yet another embodiment, the filtering circuit 196 may be configured to filter out signals with frequency of approximately 500 KHz or 50 MHz from the first and second periodic signals 102, 104.

Referring to FIG. 1D, the signal conditioning circuit 195 may comprise an amplitude adjustor circuit 197. The error detector circuit 140 and the signal conditioning circuit 195 may be configured to receive the first and second periodic signals 102, 104. The error detector circuit 140 may be configured to generate the error signal 142 when the maximum values 102a, 104a of the first and second periodic signals 102, 104 fall below the first range 123. The signal conditioning circuit 195 may be configured to reconstruct the first and second periodic signals 102, 104 into the reconstructed first and second periodic signals 181, 182 respectively. The amplitude adjustor circuit 197 may be configured to adjust the first and second periodic signals 102, 104 into the reconstructed first and second periodic signals 181, 182 when the error detector circuit 140 may be configured to generate the error signal 142. In one embodiment where the first and second periodic signals 102, 104 are received as electrical voltages, the amplitude adjustor circuit 197 may be configured to adjust the first and second periodic signals 102, 104 by increasing or decreasing voltages of the first and second periodic signals 102, 104. In another embodiment where the first and second periodic signals 102 and 104 are received as electrical currents, the amplitude adjustor circuit 197 may be configured to adjust the first and second periodic signals 102, 104 by increasing or decreasing the currents of the first and second periodic signals 102, 104.

Referring to FIGS. 1D-1E, the signal conditioning circuit 195 may comprise a controller 191. The signal conditioning circuit 195 of the encoder system 100 may be coupled to the error detector circuit 140 and the sensor array 170. The sensor array 170 may generate first and second periodic signals 102, 104 with the maximum values 102a, 104a that fall below the first range 123, which may be due to contamination on the encoder system 100 or degradation of the emitter 171. As a result, the error detector circuit 140 may be configured to generate the error signal 142. As a response to the error signal 142, the signal conditioning circuit 195 may be configured to adjust an intensity of the light 149 emitted by the emitter 171. The controller 191 may be configured to increase a drive current of the emitter 171 such that the sensor array 170 may generate first and second periodic signals 102, 104 with maximum values 102a, 104a that fall within the first range 123.

In one embodiment, the detection controller 110 may be coupled to the sensor array 170 indirectly via the signal conditioning circuit 195 as illustrated in FIG. 1E. The signal conditioning circuit 195 may be configured to reconstruct the first and second periodic signals 102, 104 into the reconstructed first and second periodic signals 181,182. The signal conditioning circuit 195 may be configured to filter the noise from the first and second periodic signals 102, 104 so as to generate the reconstructed first and second periodic signals 181, 182. The detection controller 110 may be configured to generate the periodic control signal 112 that may be derived from the reconstructed first and second periodic signals 181, 182 instead of the first and second periodic signals 102, 104. By generating the periodic control signal 112 from the reconstructed first and second periodic signals 181, 182, the detection controller 110 may be prevented from generating the periodic control signal 112 that may indicate a false maximum value of the first and second periodic signals 102, 104, which may occur due to the noise.

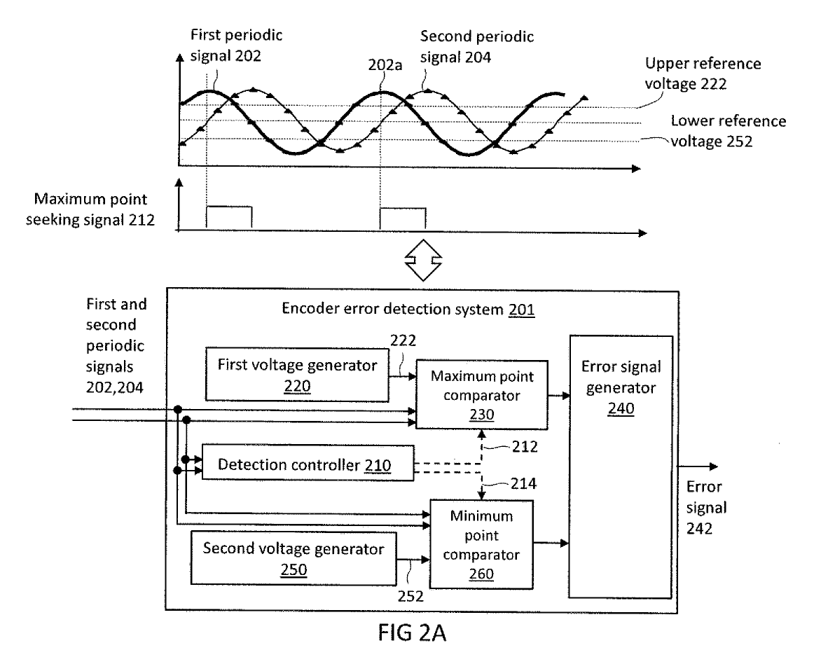

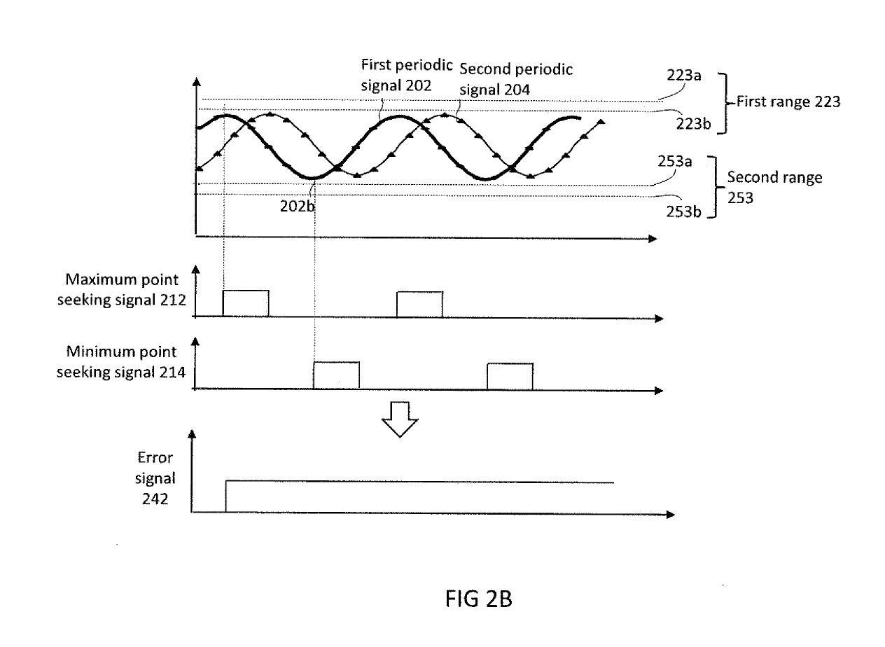

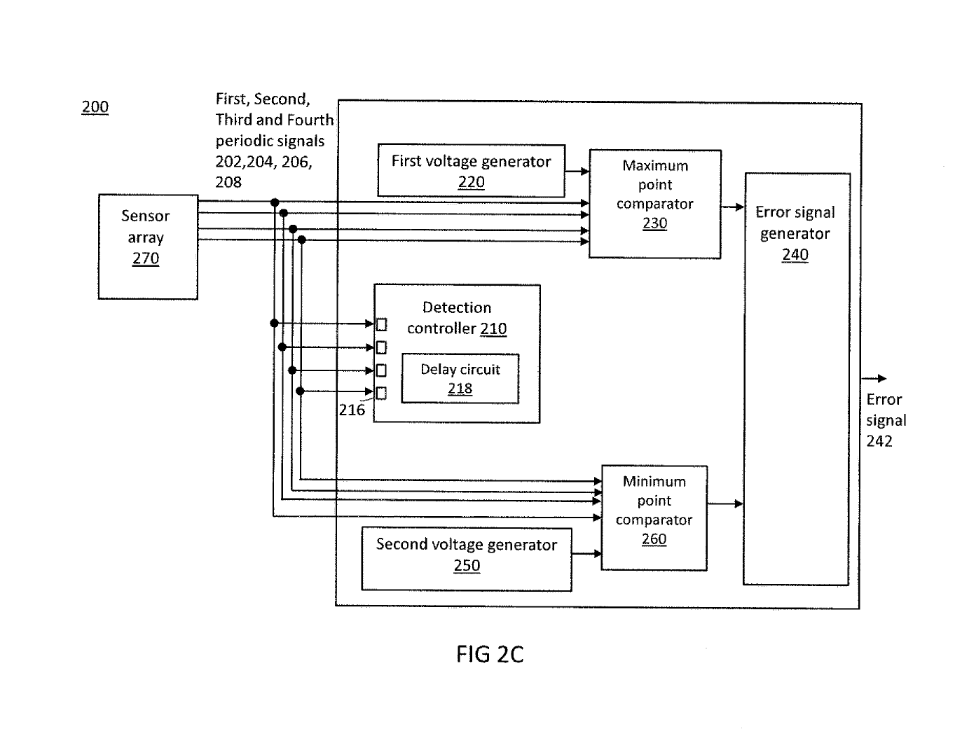

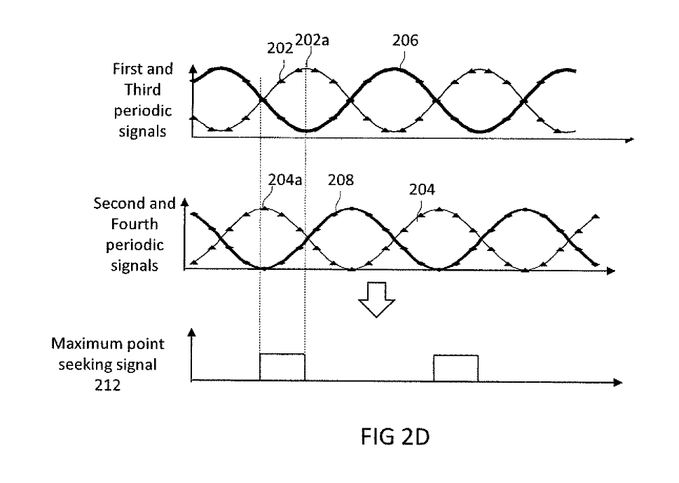

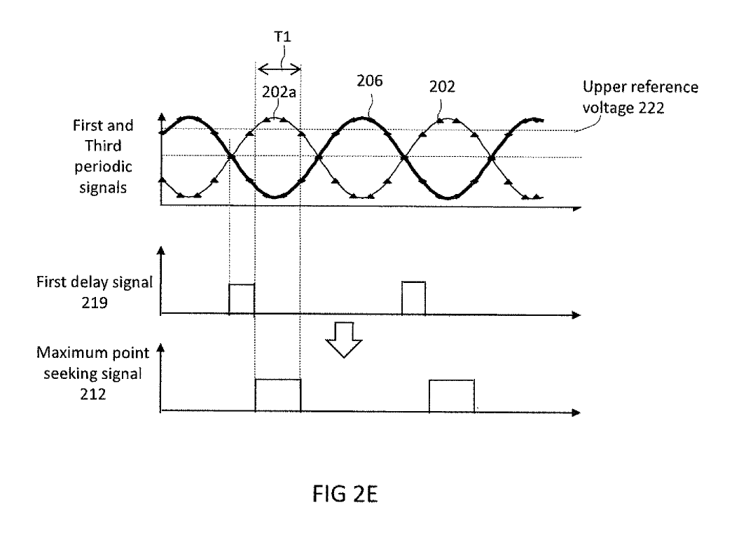

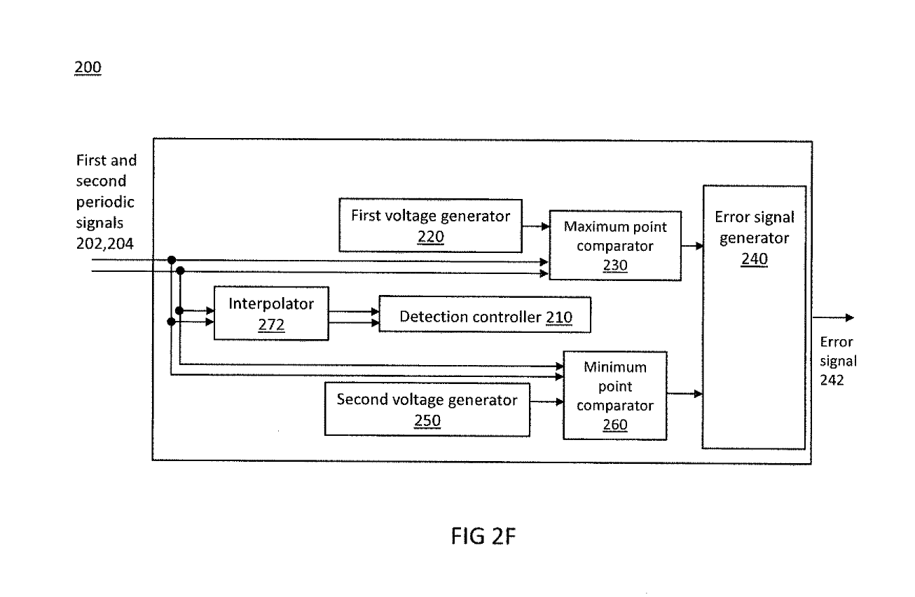

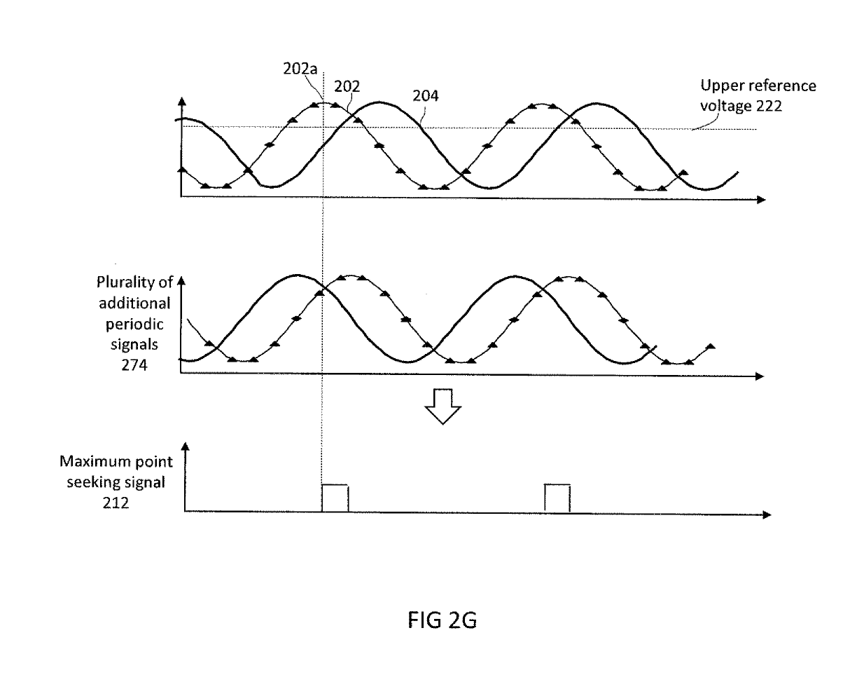

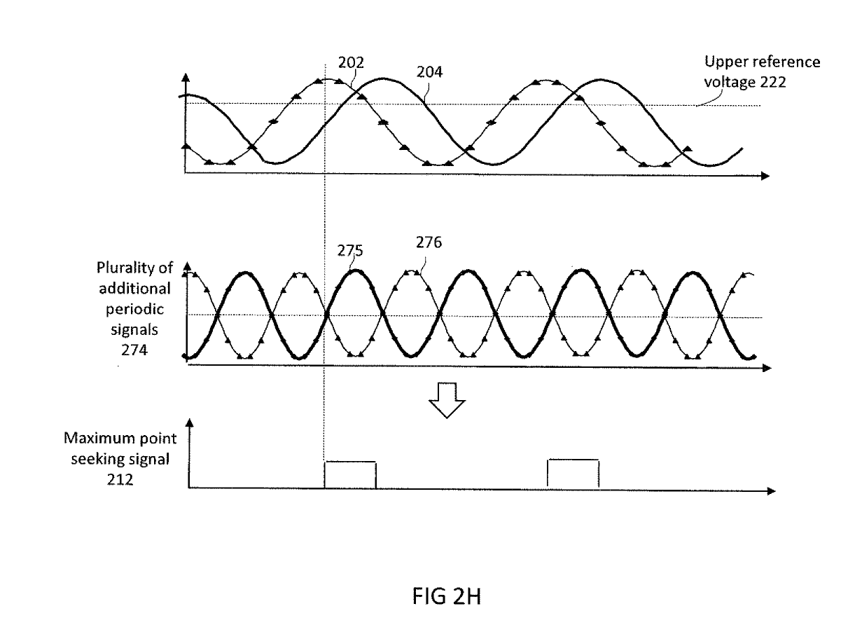

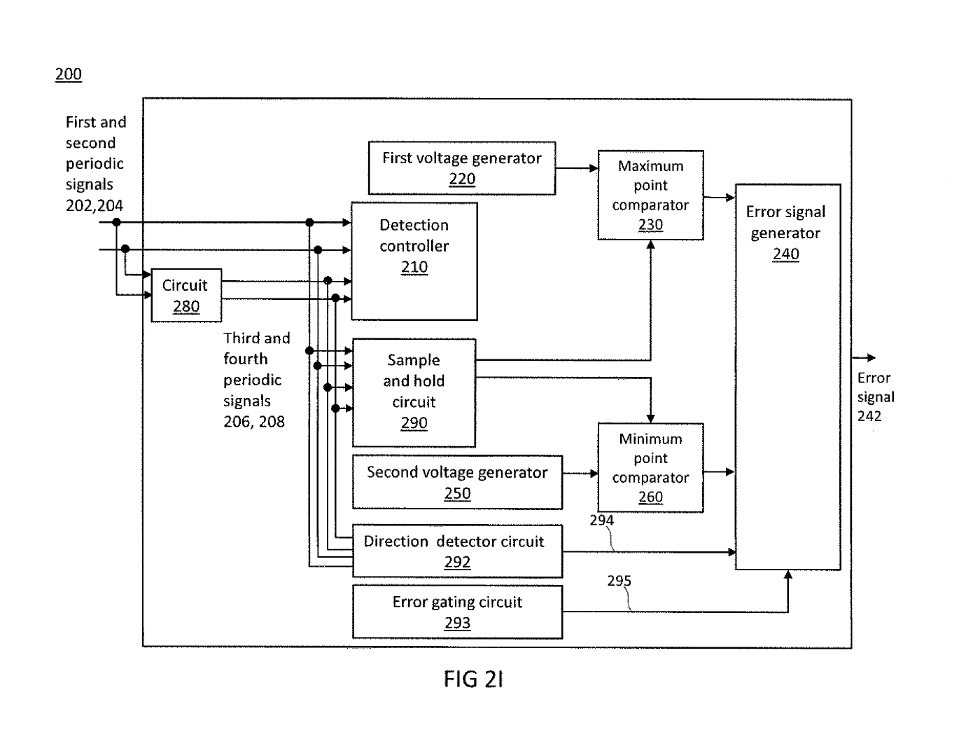

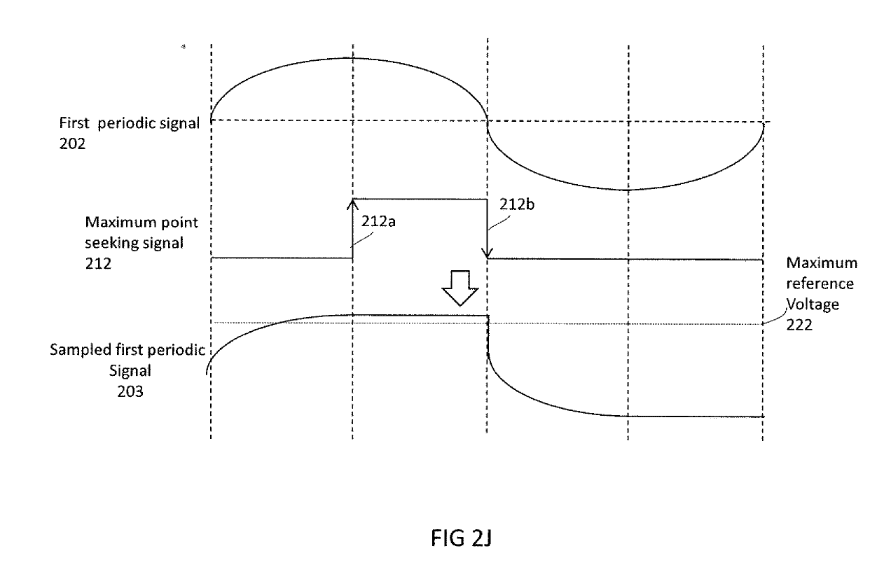

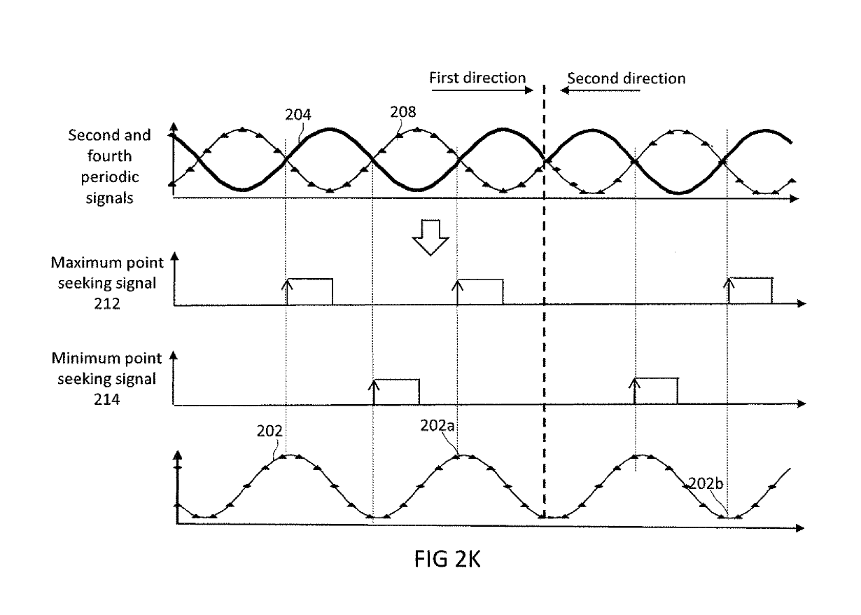

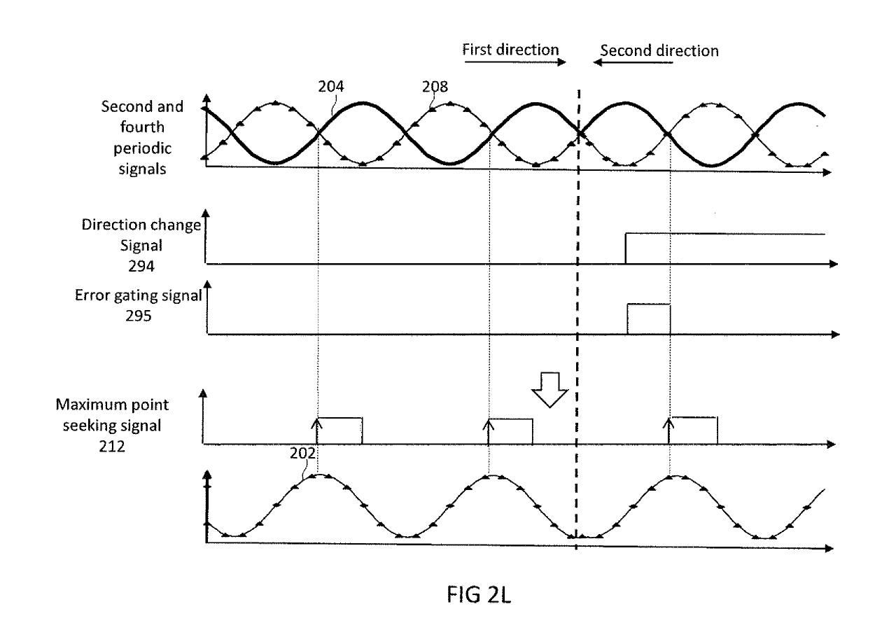

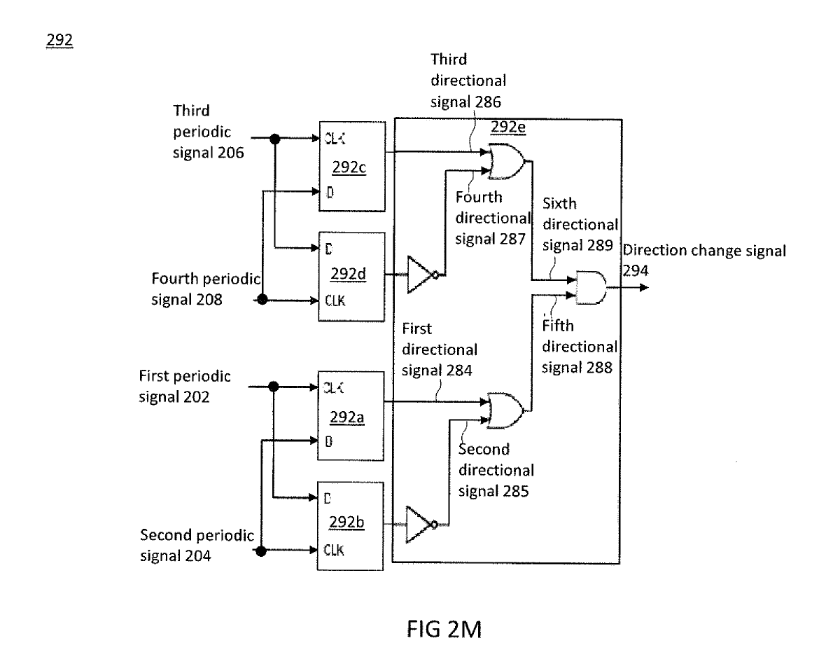

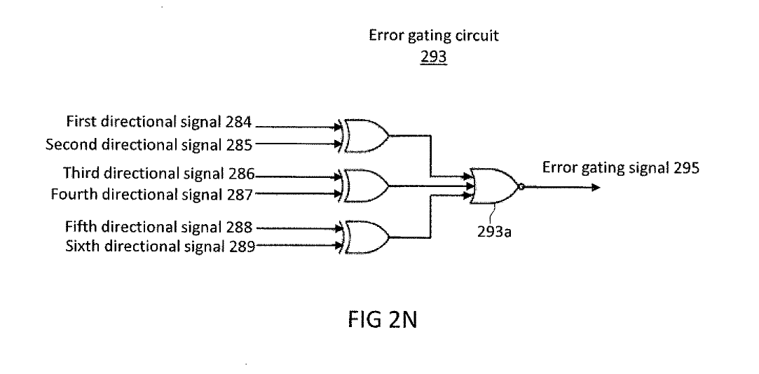

Referring to FIGS. 2A-2N, the encoder system 200 may comprise a detection controller 210, a first voltage generator 220, a second voltage generator 250, a maximum point comparator 230, a minimum point comparator 260, and an error signal generator 240. The encoder system 200 may be similar with or identical to the encoder system 100. The encoder system 200 may be configured to monitor a first periodic signal 202 and a second periodic signal 204 that may be approximately 90 degrees out of phase from one another.

Referring to FIG. 2A, the detection controller 210 may be configured to receive the first and second periodic signals 202, 204. The detection controller 210 may be configured to generate a maximum point seeking signal 212 from at least one of the first and second periodic signals 202, 204. The detection controller 210 may be configured to generate the maximum point seeking signal 212 that corresponds to a maximum value 202a of at least one of the first and second periodic signals 202, 204.

The first voltage generator 220 may be configured to generate an upper reference voltage 222. The maximum point comparator 230 may be coupled to the detection controller 210 and the first voltage generator 220. The maximum point comparator 230 may be configured to compare at least one of the first and second periodic signals 202, 204 to the upper reference voltage 222 when the maximum point seeking signal 212 is triggered. The error signal generator 240 may be coupled to the maximum point comparator 230. The error signal generator 240 may be substantially similar with the error detector circuit 140.

The error signal generator 240 may be configured to generate the error signal 242 when the maximum point seeking signal 212 is triggered, which is when the maximum point seeking signal 212 may be equal to a predetermined digital value such as 0 or 1 as illustrated in FIG. 2A. In one embodiment, the error signal generator 240 may be configured to generate the error signal 242 when the maximum point seeking signal 212 is equal to a predetermined analog value such as 1 mV or 10 mV. In another embodiment, the error signal generator 240 may be configured to generate the error signal 242 at a positive edge or a negative edge 212a, 212b of the maximum point seeking signal 212 as illustrated in FIG. 2J. in yet another embodiment, the error signal generator 240 may be configured to generate the error signal 242 when the maximum point seeking signal 212 may be equal to a predetermined multiple bits value such as 01, 10 or 001.

The error signal generator 240 may be configured to generate an error signal 242 when triggered by the maximum point comparator 230. The error signal generator 240 may be configured to generate the error signal 242 when the maximum point comparator 230 indicates that at least one of the first and second periodic signals 202, 204 is lower than the upper reference voltage 222. Referring to FIGS. 2A-26, the first voltage generator 220 may be configured to generate a first range 223 that comprises a first upper reference voltage 223a and second upper reference voltage 223b. The maximum point comparator 230 may be configured to compare the first and second periodic signals 202, 204 with the first and second upper reference voltages 223a, 223b. The maximum point comparator 230 may be configured to indicate that the first and second periodic signals 202, 204 are outside the first range 223 when at least one of the first and second periodic signals 202, 204 is higher than the first upper reference voltage 223a or lower than the second upper reference voltage 223b. The error signal generator 240 may be configured to generate the error signal 242 when the maximum point comparator 230 indicates that at least one of the first and second periodic signals 202, 204 is outside the first range 223.

The detection controller 210 may be configured to generate a minimum point seeking signal 214 from at least one of the first and second periodic signals 202, 204. The minimum point seeking signal 214 may correspond to a minimum value 202b of the first periodic signal 202. The second voltage generator 250 may be configured to generate a lower reference voltage 252. The minimum point comparator 260 may be coupled to the detection controller 210 and the second voltage generator 250. The minimum point comparator 260 may be configured to compare the first periodic signal 202 and the lower reference voltage 252 when the minimum point seeking signal 214 is triggered. The detection controller 210 may be configured to generate the minimum point seeking signal 214 as digital signal, analog signal, or multiple bits signal. The minimum point seeking signal 214 may share similar characteristics with the periodic control signal 112 in FIGS. 1A-1E.

The error signal generator 240 may be coupled to the minimum point comparator 260. The error signal generator 240 may be configured to generate the error signal 242 when triggered by the minimum point comparator 260. The error signal generator 240 may be configured to generate the error signal 242 when the minimum point comparator 260 generates an output that may indicate at least one of the first and second periodic signals 202, 204 may be higher than the lower reference voltage 252.

In one embodiment, the second voltage generator 250 may be configured to generate a second range 253 that comprises a first lower reference voltage 253a and second lower reference voltage 253b. The minimum point comparator 260 may be configured to compare the first and second periodic signals 202, 204 with the first and second lower reference voltages 253a, 253b. The minimum point comparator 260 may be configured to indicate that the first and second periodic signals 202, 204 is outside the second range 253 when at least one of the first and second periodic signals 202, 204 is higher than the first lower reference voltage 253a or lower than the second lower reference voltage 253b. The error signal generator 240 may be configured to generate the error signal 242 when the minimum point comparator 260 generates an output that indicates at least one of the first and second periodic signals 202, 204 may be outside the second range 253.

Referring to FIG. 2C, the encoder system 200 may comprise a sensor array 270. The sensor array 270 may be configured to generate the first and second periodic signals 202, 204. The sensor array 270 may be configured to generate a third periodic signal 206 that may be approximately 180 degrees out of phase relative to the first periodic signal 202 and a fourth periodic signal 208 that may be approximately 180 degrees out of phase relative to the second periodic signal 204.

The detection controller 210 may comprise a plurality of terminals 216. The plurality of terminals 216 may be configured to receive the third periodic signal 206 and the fourth periodic signal 208. The third periodic signal 206 may be approximately 180 degrees out of phase relative to the first periodic signal 202. The fourth periodic signal 208 may be approximately 180 degrees out of phase relative to the second periodic signal 204. Referring to FIGS. 2C-2D, the detection controller 210 may be configured to trigger the maximum point seeking signal 212 when at least two of the first, second, third and fourth periodic signals 202, 204, 206, 208 cross one another.

In one embodiment, the detection controller 210 may be configured to trigger the maximum point seeking signal 212 when the first and third periodic signals 202, 206 cross one another. The maximum point seeking signal 212 may change from one digital value to another digital value when the first and third periodic signals 202, 206 cross one another. The maximum point seeking signal 212 may correspond to the maximum value 204a of the second periodic signal 204 when the first and third periodic signals 202, 206 cross one another. The maximum point comparator 230 may be configured to compare the second periodic signal 204 with the upper reference voltage 222 when the first and third periodic signals 202, 206 cross one another.

In another embodiment, the detection controller 210 may be configured to trigger the maximum point seeking signal 212 when the second and fourth periodic signals 204, 208 cross one another. The maximum point seeking signal 212 may change from the one digital value to another digital value when the second and fourth periodic signals 204, 208 cross one another. The change in the digital value of the maximum point seeking signal 212 may correspond to the maximum value of the first periodic signal 202. The maximum point comparator 230 may be configured to compare the first periodic signal 202 with the upper reference voltage 222 when the second and fourth periodic signals 204, 208 cross one another.

Referring to FIGS. 2C-2E, the detection controller 210 may be configured to trigger the maximum point seeking signal 212 when the first periodic signal 202 is larger than the third periodic signal 206. In another embodiment, the detection controller 210 may be configured to trigger the maximum point seeking signal 212 when the third periodic signal 206 is larger than the first periodic signal 202.

The detection controller 210 may further comprise a delay circuit 218. The delay circuit 218 may be configured to delay the maximum point seeking signal 212. The delay circuit 218 may be configured to generate the first delay signal 219 when the first and third periodic signals 202, 206 cross one another. The delay circuit 218 may be configured to delay the maximum point seeking signal 212 by at least approximately 5 ns but approximately shorter than 1 ms. Referring to FIG. 2D, the maximum point seeking signal 212 may indicate the maximum value 202a of the first periodic signal 202 when the second and fourth periodic signals 204, 208 cross one another. However, when there is a distortion on the first periodic signal 202, the maximum point seeking signal 212 may indicate another value that may not be the maximum value 202a of the first periodic signal 202 when the second and fourth periodic signals 204, 208 cross one another. As a result, the maximum point comparator 230 may compare an incorrect maximum value with the upper reference voltage 222 and the error signal generator 240 may generate a false error signal 242.

By delaying the maximum point seeking signal 212 by at least approximately 5 ns but approximately shorter than 1 ms, the maximum point comparator 230 may be configured to compare the first periodic signal 202 during a first period T1 rather than at a specific time when the second and fourth periodic signals 204,208 cross one another. When there is signal distortion on the first periodic signal 202, the maximum value 202a may not occur at the time when the second and fourth periodic signals 204, 208 cross one another, but the maximum value 202a may occur within the first period T1. By comparing the first periodic signal 202 during the first period T1, the maximum point comparator 230 may compare the first periodic signal 202 that may comprise the maximum value 202a. As a result, the maximum point comparator 230 may compare the first periodic signal 202 with the upper reference voltage 222 without being affected by signal distortion and prevent the error signal generator 240 from generating false error signal 242.

Referring to FIGS. 2F-2G, the encoder system 200 may further comprise an interpolator 272. The interpolator 272 may be configured to generate a plurality of additional periodic signals 274. In one embodiment, the interpolator 272 may be configured to generate the plurality of additional periodic signals 274 that may be approximately less than 45 degrees out of phase relative to the first periodic signal 202. In another embodiment, the interpolator 272 may be configured to generate the plurality of additional periodic signals 274 that may be approximately less than 45 degrees out of phase relative to the second periodic signal 204.

The detection controller 210 may be configured to trigger the maximum point seeking signal 212 when at least two of the plurality of additional periodic signals 274 cross one another. The maximum point comparator 230 may be configured to compare the first periodic signal 202 with the upper reference voltage 222 when at least two of the plurality of additional periodic signals 274 cross one another. The detection controller 210 may be configured to generate the maximum point seeking signal 212 that may correspond to the maximum value 202a of the first periodic signal 202 when the at least two of the plurality of additional periodic signals 274 cross one another.

Referring to FIGS. 2F-2H, the encoder system 200 may be configured to receive the first periodic signal 202 that has a first frequency. The interpolator 272 may be configured to generate the plurality of additional periodic signals 274 that may comprise high frequency signals 275, 276. The high frequency signals 275, 276 may have a frequency that is at least approximately two times the first frequency. The detection controller 210 may be configured to generate the maximum point seeking signal 212 when the high frequency signals 275, 276 cross one another. The maximum point comparator 230 may be configured to compare the first periodic signal 202 with the upper reference voltage 222 when the high frequency signals 275, 276 cross one another.

Referring to FIG. 21, the encoder system 200 may comprise a circuit 280. The first and second periodic signals 202, 204 may be provided as inputs to the circuit 280. The circuit 280 may be coupled to. The circuit 280 may be configured to generate, as outputs, a third periodic signal 206 that is approximately 180 degrees out of phase relative to the first periodic signal 202, and a fourth periodic signal 208 that is approximately 180 degrees out of phase relative to the second periodic signal 204.

Referring to FIGS. 2I-2J, the encoder system 200 may further comprise a sample and hold circuit 290. The detection controller 210 may be configured to generate the maximum point seeking signal 212 that has a rising edge 212a and a falling edge 212b. The maximum point comparator 230 may be triggered to compare at least one of the first and second periodic signals 202, 204 to the upper reference voltage 222 at one of the rising edge and the falling edge 212a, 212b. The sample and hold circuit 290 may be configured to store at least one of the first and second periodic signals 202, 204 at one of the rising edge and the falling edge 212a, 212b of the maximum point seeking signal 212. The sample and hold circuit 290 may be configured to generate the sampled first periodic signal 203 when triggered by the maximum point seeking signal 212. The maximum point comparator 230 may be configured to compare the sampled first periodic signal 203 with the upper reference voltage 222 at one of the rising edge and the falling edge 212a, 212b. The detection controller 110 in FIGS. 1A-1E may be substantially similar with the detection controller 210 shown in FIGS. 2A-2I.

Referring to FIGS. 2I, 2K and 2L, the encoder system 200 may comprise a direction detector circuit 292 and an error gating circuit 293. The encoder system 200 may be configured to receive the first and second periodic signals 202, 204 that may be generated in accordance to a rotation of a motor (not shown) rotating in a first direction.

Referring to FIGS. 2I and 2K, the detection controller 210 may be configured to generate the maximum point seeking signal 212 when the second and fourth periodic signals 204, 208 cross one another. The detection controller 210 may be configured to generate the maximum point seeking signal 212 when the second periodic signal 204 begins to become larger than the fourth periodic signal 208. When the motor (not shown) rotates in the first direction, the maximum point seeking signal 212 may correspond to the maximum value 202a of the first periodic signal 202. However, when the motor (not shown) rotates in a second direction, the maximum point seeking signal 212, which may be still triggered when the second periodic signal 204 becomes larger than the fourth periodic signal 208, may correspond to a minimum value 202b instead of the maximum value 202a of the first periodic signal 202. As a result, the maximum point comparator 230 may be configured to compare the minimum value 202b of the first periodic signal 202 with the upper reference voltage 222 and the error signal generator 240 may be configured to generate a false error signal 242.

Referring to FIGS. 2I, 2K-2L, the direction detector circuit 292 may be configured to trigger a direction change signal 294 when the motor (not shown) or motor part is configured to rotate in the second direction differing from the first direction. The detection controller 210 may be configured to generate a minimum point seeking signal 214 that correspond to the maximum value 202a of the first periodic signal 202 in the second direction. The error signal generator 240 may be configured to switch the minimum point seeking signal 214 with the maximum point seeking signal 212 in response to the direction change signal 294. As a result, the maximum point comparator 230 may be configured to compare the maximum value 202a instead of the minimum value 202b of the first periodic signal 202 with the upper reference voltage 222 and prevent the error signal generator 240 from generating the false error signal 242.

As discussed in the earlier paragraph, the detection controller 210 may be configured to generate the maximum point seeking signal 212 when the second periodic signal 204 may be larger than the fourth periodic signal 208 in the first direction. In one embodiment, the detection controller 210 may be configured to switch the second periodic signal 204 with the fourth periodic signal 208 when the direction change signal 294 is triggered. As a result, the detection controller 210 may be configured to generate the maximum point seeking signal 212 when the fourth periodic signal 208 is larger than the second periodic signal 204. By switching the second and fourth periodic signals 204, 208, the detection controller 210 may be configured to generate the maximum point seeking signal 212 that correspond to the maximum value 202a of the first periodic signal 202 when the motor (not shown) rotates in the second direction and prevent the error signal generator 240 from generating the false error signal 242.

In another embodiment, the error signal generator 240 may be configured to cease generating the error signal 242 when the motor (not shown) rotates in the second direction differing from the first direction. The error gating circuit 293 may be configured to generate the error gating signal 295 when the direction change signal 294 is triggered. The error signal generator 240 may be configured to cease generating the error signal 242 temporarily in response to the error gating signal 295. The error signal generator 240 may be configured to resume generating the error signal 242 after the error signal generator 240 completes the switch between the maximum point seeking signal 212 and the minimum point seeking signal 214.

Referring to FIG. 2M, the direction detector circuit 292 may comprise a plurality of flip-flop circuits 292a, 292b, 292c, 292d and a logic gate circuit 292e. The third and fourth member of the plurality of the flip-flop circuits 292c, 292d may be configured to receive the third and fourth periodic signals 206, 208 as inputs. The third and fourth member of the plurality of the flip-flop circuits 292c, 292d may be configured to generate third and fourth directional signals 286, 287 as outputs. The logic gate circuit 292e may be configured to generate a sixth directional signal 289 from the third and fourth periodic signals 206, 208.

The first and second members of the plurality of the flip-flop circuits 292a, 292b may be configured to generate first and second directional signals 284, 285 from the first and second periodic signals 202, 204. The logic gate circuit 292e may be configured to generate a fifth directional signal 288 from the first and second directional signals 284, 285. The logic gate circuit 292e may be configured to generate the direction change signal 294 from the fifth and sixth directional signals 288, 289. The direction detector circuit 292 may be substantially similar with the direction detector circuit 192 in FIG. 1A.

Referring to FIG. 2N, the error gating circuit 293 may comprise a plurality of logic gates 293a. The error gating circuit 293 may be configured to generate the error gating signal 295 from the first, second, third, fourth, fifth and sixth directional signals 284, 285, 286, 287, 288, 289.

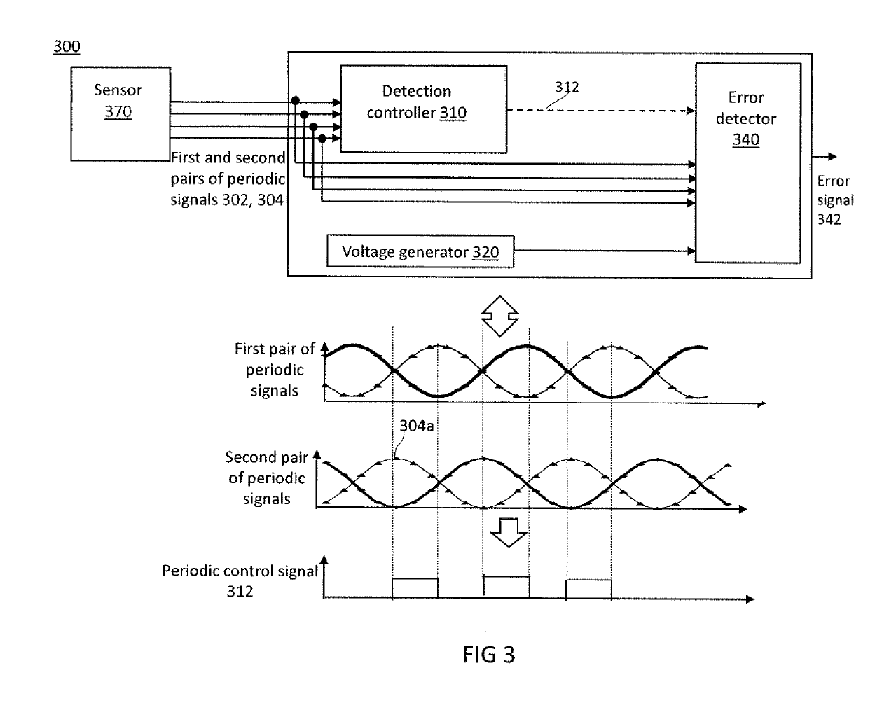

Referring to FIG. 3, an encoder system 300 may comprise a sensor 370, a detection controller 310, a voltage generator 320, and an error detector 340. The encoder system 300 may be substantially similar with the encoder systems 100, 200. The sensor 370 may be configured to generate first and second pairs of periodic signals 302, 304. The first pair of periodic signals 302 may be approximately 90 degrees out of phase from the second pair of periodic signal 304. The detection controller 310 may be coupled to the sensor 370. The detection controller 310 may be configured to generate a periodic control signal 312 derived from at least one of the first and second pairs of periodic signals 302, 304. The detection controller 310 may be configured to generate the periodic control signal 312 when members of the first pair of periodic signals 302 cross one another. The detection controller 310 may be configured to generate the periodic control signal 312 that may correspond to a maximum value 304a of at least one member of the second pair of periodic signals 304. In another embodiment, the detection controller 310 may be configured to generate the periodic control signal 312 when members of the second pair of periodic signals 302 cross one another.

The voltage generator 320 may be configured to generate a reference range. The error detector 340 may be coupled to the detection controller 310 and the voltage generator 320. The error detector 340 may be configured to generate an error signal 342 when at least one member of the first and second pairs of periodic signals 302, 304 is outside the reference range when the periodic control signal 312 is triggered.

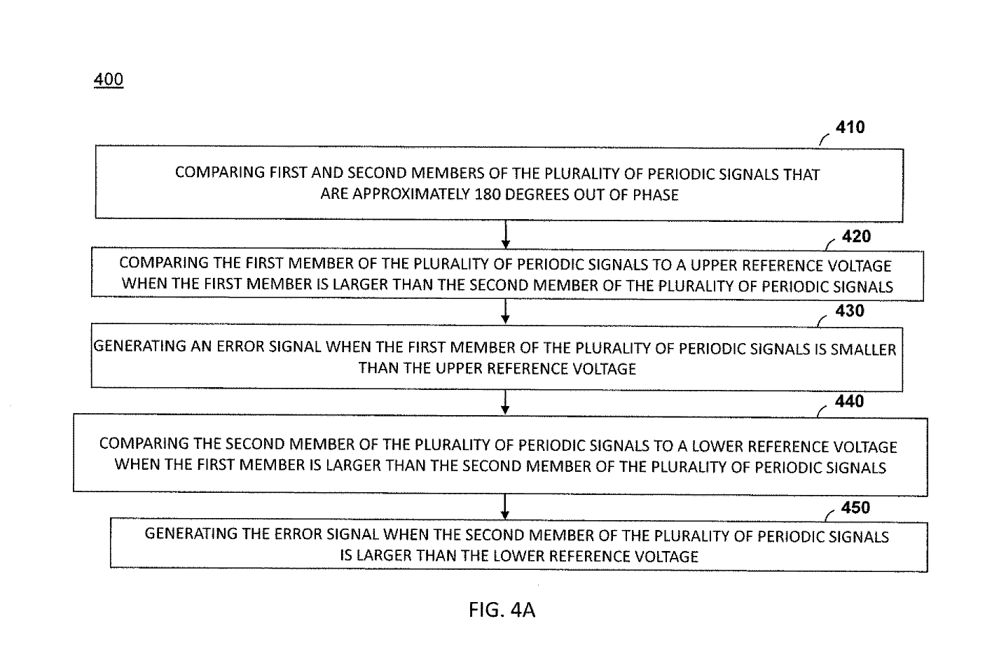

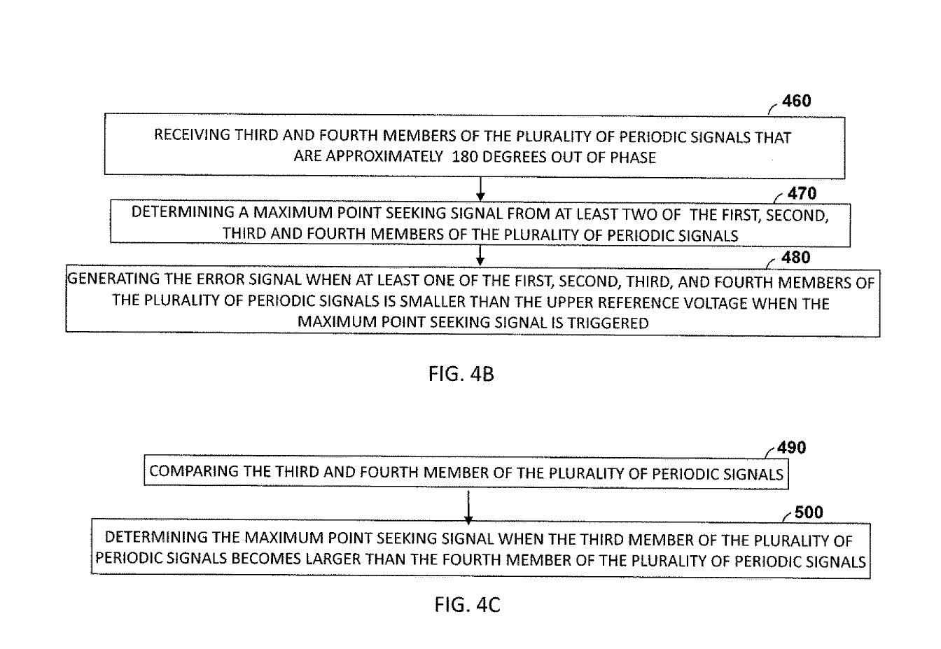

FIGS. 4A-4C illustrate flowcharts showing a method for detecting error in a plurality of periodic signals produced by an encoder. Referring to FIG. 4A, the method may comprise comparing first and second members of the plurality of periodic signals that are approximately 180 degrees out of phase in Step 410. In Step 420, the first member of the plurality of periodic signals may be compared to a upper reference voltage when the first member is larger than the second member of the plurality of periodic signals. In Step 430, an error signal may be generated when the first member of the plurality of periodic signals is smaller than the upper reference voltage. In Step 440, the second member of the plurality of periodic signals may be compared to a lower reference voltage when the first member is larger than the second member of the plurality of periodic signals. In Step 450, the error signal may be generated when the second member of the plurality of periodic signals is larger than the lower reference voltage.

Alternatively, the method for detecting error in the plurality of periodic signals may proceed from Step 430 to optional Steps 460 to 480 as illustrated in FIG. 4B. In Step 460, third and fourth members of the plurality of periodic signals that are approximately 180 degrees out of phase may be received. In Step 470, a maximum point seeking signal may be determined from at least two of the first, second, third and fourth members of the plurality of periodic signals. In Step 480, the error signal may be generated when at least one of the first, second, third, and fourth members of the plurality of periodic signals is smaller than the upper reference voltage when the maximum point seeking signal is triggered. Referring to FIG. 4C, determining the maximum point seeking signal in Step 470 may comprise comparing the third and fourth member of the plurality of periodic signals in Step 490. In Step 500, the maximum point seeking signal may be determined when the third member of the plurality of periodic signals becomes larger than the fourth member of the plurality of periodic signals.

Different aspects, embodiments or implementations may, but need not, yield one or more of the advantages. For example the delay circuit may be configured to delay the maximum point seeking signal by at least approximately 5 ns but approximately shorter than 1 ms so as to prevent the error signal generator generates incorrect error signal that may be due to signal distortion on the first and second periodic signals. In another example, the filtering circuit may be configured to filter out signals having a frequency approximately higher than 5 MHz when the error detector circuit generates the error signal so as to reconstruct the first and second periodic signals to be within the first range or the second range.

Although specific embodiments of the invention have been described and illustrated herein above, the invention should not be limited to any specific forms or arrangements of parts so described and illustrated. For example, the encoder assembly described above may be a transmissive encoder, a reflective encoder, an absolute encoder, an incremental encoder or any other types of encoder. The scope of the invention is to be defined by the claims.

What is claimed is:

1. An encoder system for detecting a movement of a part of a motor system, comprising:
a sensor array configured to generate first and second periodic signals in accordance to the movement of the part of the motor system;
a detection controller coupled to the sensor array, wherein the detection controller is configured to receive the first and second periodic signals, and wherein the detection controller is configured to generate a periodic control signal derived from at least one of the first and second periodic signals; and
an error detector circuit coupled to the sensor array and the detection controller, wherein the error detector circuit is configured to generate an error signal when at least one of the first and second periodic signals is outside a predetermined range when the periodic control signal is triggered.

2. The encoder system of claim 1, further comprising a signal conditioning circuit, wherein the signal conditioning circuit is coupled to the error detector circuit and the sensor array.

3. The encoder system of claim 2, wherein the signal conditioning circuit is configured to reconstruct the first and second periodic signals into reconstructed first and second periodic signals respectively.

4. The encoder system of claim 2, wherein the signal conditioning circuit comprises a filtering circuit.

5. The encoder system of claim 2, wherein the signal conditioning circuit comprises an amplitude adjustor circuit.

6. An encoder system for monitoring a first periodic signal and a second periodic signal that are approximately 90 degrees out of phase, comprising:
a detection controller configured to receive the first and second periodic signals, wherein the detection controller is configured to generate a maximum point seeking signal from at least one of the first and second periodic signals;
a first voltage generator configured to generate a upper reference voltage;
a maximum point comparator coupled to the detection controller and the first voltage generator, the maximum point comparator being configured to compare at least one of the first and second periodic signals to the upper reference voltage when the maximum point seeking signal is triggered; and
an error signal generator coupled to the maximum point comparator configured to generate an error signal when triggered by the maximum point comparator.

7. The encoder system of claim 6, wherein the error signal generator is configured to generate the error signal when the maximum point comparator indicates that at least one of the first and second periodic signals is lower than the upper reference voltage.

8. The encoder system of claim 6, wherein the detection controller is configured to generate a minimum point seeking signal from at least one of the first and second periodic signals.

9. The encoder system of claim 8, further comprising:
a second voltage generator configured to generate a lower reference voltage; and
a minimum point comparator coupled to the detection controller and the second voltage generator and configured to compare the first periodic signal and the lower reference voltage when the minimum point seeking signal is triggered,
wherein the error signal generator is coupled to the minimum point comparator and is configured to generate the error signal.

10. The encoder system of claim 8, wherein:
the first and second periodic signals are generated in accordance to a rotation of a motor rotating in a first direction;
the encoder system further comprises a direction detector circuit configured to trigger a direction change signal when the motor is configured to rotate in a second direction differing from the first direction; and
the error signal generator is configured to switch the minimum point seeking signal with the maximum point seeking signal in response to the direction change signal.

11. The encoder system of claim 6, further comprising a sensor array, wherein the sensor array is configured to generate the first periodic signal, the second periodic signal, and a third periodic signal that is approximately 180 degrees out of phase relative to the first periodic signal, and a fourth periodic signal that is approximately 180 degrees out of phase relative to the second periodic signal.

12. The encoder system of claim 11 further comprising a signal conditioning circuit, wherein the detection controller is coupled to the sensor array indirectly via the signal conditioning circuit.

13. The encoder system of claim 6, further comprising a circuit coupled to the first and second periodic signals as inputs and configured to generate, as outputs, a third periodic signal that is approximately 180 degrees out of phase relative to the first periodic signal, and a fourth periodic signal that is approximately 180 degrees out of phase relative to the second periodic signal.

14. The encoder system of claim 6, wherein the detection controller comprises a plurality of terminals configured to receive a third periodic signal that is approximately 180 degrees out of phase relative to the first periodic signal, and a fourth periodic signal that is approximately 180 degrees out of phase relative to the second periodic signal.

15. The encoder system of claim 14, wherein the detection controller is configured to trigger the maximum point seeking signal when at least two of the first, second, third and fourth periodic signals cross one another.

16. The encoder system of claim 6, wherein the detection controller further comprises a delay circuit for delaying the maximum point seeking signal.

17. The encoder system of claim 6, wherein the maximum point seeking signal has a falling edge and a rising edge, and wherein the maximum point comparator is triggered to compare at least one of the first and second periodic signals to the upper reference voltage at one of the rising edge and the falling edge.

18. The encoder system of claim 17 further comprising a sample and hold circuit configured to store at least one of the first and second periodic signals at one of the rising edge and the falling edge of the maximum point seeking signal.

19. The encoder system of claim 6 further comprising an interpolator, wherein:
the interpolator is configured to generate a plurality of additional periodic signals; and
the detection controller is configured to trigger the maximum point seeking signal when at least two of the plurality of additional periodic signals cross one another.

20. A method for detecting error in a plurality of periodic signals of an encoder, comprising:
comparing first and second members of the plurality of periodic signals that are approximately 180 degrees out of phase;
comparing the first member of the plurality of periodic signals to a upper reference voltage when the first member is larger than the second member of the plurality of periodic signals; and
generating an error signal when the first member of the plurality of periodic signals is smaller than the upper reference voltage.
